(19) United States
(12) Patent Application Publication
(10) Pub. No.: US 2024/0265479 A1
(43) Pub. Date: Aug. 8, 2024

(54) NETWORK INFORMATION SYSTEM AND COMPUTER OF GRADING PROFESSIONAL SERVICES AND AWARDING SERVICE PROVIDERS AND METHOD THEREOF

(71) Applicants: Zhenkun Wang, Cambridge, MA (US); Charlotte Xiyou Wang, Cambridge, MA (US)

(72) Inventors: Zhenkun Wang, Cambridge, MA (US); Charlotte Xiyou Wang, Cambridge, MA (US)

(21) Appl. No.: 18/106,830

(22) Filed: Feb. 7, 2023

(51) Int. Cl. G06Q 50/18; G06Q 30/0282

(52) U.S. Cl. CPC G06Q 50/18; G06Q 30/0282; H04L 67/12

(57) ABSTRACT

A method, comprising: receiving description of a lawsuit case from a first client-side component of a litigant via a network and establishing the new lawsuit case in a database management system according to the description; transmitting the description of the newly establishing lawsuit case to one or more second client-side components of lawyers via the network; receiving one or more requests from one or more of the second client-side components of lawyers via the network; transmitting the received one or more request to the first client-side component of the litigant via the network; and receiving a selection of the request(s) from the first client-side component of the litigant via the network and associating the lawyer with the lawsuit case and the litigant.

### FIELD OF THE INVENTION

The present invention relates to a network information system, and more particularly, to a network information system of grading professional services and awarding service providers.

### BACKGROUND OF THE INVENTION

Lawsuit cases are not common for normal people. When having a lawsuit, there may not have many opportunities to get a suitable lawyer without paying service fee. For many people, hiring a qualified lawyer is unaffordable. This made having lawsuits become games of rich men. For lawyers, it also lacks a public platform to show their professions and to provide free public services for the normal people.

Hence, it is desired to have a network information system for providing opportunities to lawyers having wills to provide free professional services to those who need. Via this network information system, people can have chances to review the provided services of these enthusiastic lawyers and even to grade the judgements over these lawsuits. The best lawyers selected by users of the network information system may be rewarded by incomes of advertisements of this network information system.

In addition, other kinds of professional services may require public supervisions. For examples, teaching and coaching are two kinds of professional services provided by teachers and coaches. There exists a need of a network information system for providing feedbacks, comments and/or grades of professional services from the public. The network information system could calculate scores of the given grades of the professional services to determine which service provider(s) are deserved to be awarded according to the calculated scores.

### SUMMARY OF THE INVENTION

An objective of the present invention is to provide a network information system for public grading professional services and awarding professional service providers.

An objective of the present invention is to provide a network information system for providing opportunities to lawyers having wills to provide free professional services to those who need and also providing awards or even rewards to those top graded lawyers.

According to one embodiment, a method for implementing a server-side component of the network information system may comprise: receiving grades of information of professional services, stored in a database management system, from fourth client-side component of users via a network; calculating scores of the received grades; and transmitting award citations to second client-side components of service providers who are corresponding to the highest scores via the network.

Preferably, in order to provide opportunities to pro bono lawyers, wherein the service providers are lawyers, the method further comprises following steps before said step of receiving grades: receiving description of a lawsuit case from a first client-side component of a litigant via a network and establishing a new lawsuit case in the database management system according to the description; transmitting the description of the newly establishing lawsuit case to the second client-side components of lawyers via the network; receiving one or more requests from the second client-side components of lawyers via the network; transmitting the received one or more request to the first client-side component of the litigant via the network; and receiving a selection of the request(s) from the first client-side component of the litigant via the network and associating the lawyer with the lawsuit case and the litigant.

Preferably, in order to provide more details of the lawsuit case, the method further comprises receiving documents of the lawsuit case from a court server, a third client-side component of a court worker or the fourth client-side components of users via the network and associating the documents with the lawsuit case.

Preferably, in order to provide information of the professional services to the public, the method further comprises transmitting information of the professional services to the fourth client-side components of users via the network prior to said step of receiving grades.

Preferably, in order to encourage the professional practices of the lawyers and/or the judges of the lawsuit cases, the grades of information of the professional services, which includes a document provided by a user, the lawyer or a judge of the lawsuit case.

Preferably, in order to notify the public that which lawyers are awarded, the method further comprises transmitting the award citations, which are based on the calculated scores of the grades, to the fourth client-side components of users via the network.

Preferably, in order to encourage the public giving unbiased grades, the method further comprises calculating differences of the grades between the received grades and their corresponding calculated scores, respectively; and transmitting an award citation to the fourth client-side component of one of the users who gives one of the grades corresponding to the lowest one of the differences via the network.

Preferably, in order to provide advertisements to users for sustaining the network information system and providing monetary rewards to the awarded lawyers, said step of transmitting the description of the newly establishing lawsuit case, said step of transmitting the received one or more requests, and said step of transmitting information of the lawsuit case further comprise transmitting advertisements or related information from an advertisement server.

Preferably, in order to prevent robotic and fake accounts hacking into the network information system, the method further comprises authenticating the fourth client-side component of the user via a second network before said step of receiving grades.

According to an embodiment of the present application, a computer for implementing a server-side component of the network information system may comprise: a networking module for connecting to a network; and a processor module, connected to the networking module and configured for executing instructions stored in a non-volatile memory to realize: receiving grades of information of professional services, stored in a database management system, from fourth client-side component of users via the network and the networking module; calculating scores of the received grades; and transmitting award citations to second client-side components of service providers who are corresponding to the highest scores via the network.

Preferably, in order to provide opportunities to pro bono lawyers, wherein the service providers are lawyers, the processor module is further configured for executing instructions stored in a non-volatile memory to realize: receiving description of a lawsuit case from a first client-side component of a litigant via the network and the networking module and establishing a new lawsuit case in the database management system according to the description; transmitting the description of the newly establishing lawsuit case to the second client-side components of lawyers via the network and the networking module; receiving one or more requests from the second client-side components of lawyers via the network and the networking module; transmitting the received one or more request to the first client-side component of the litigant via the network and the networking module; and receiving a selection of the request(s) from the first client-side component of the litigant via the network and the networking module and associating the lawyer with the lawsuit case and the litigant.

Preferably, in order to provide more details of the lawsuit case, the processor module is further configured for executing instructions stored in a non-volatile memory to realize receiving documents of the lawsuit case from a court server, a third client-side component of a court worker, or the fourth client-side components of users via the network and the networking module and associating the documents with the lawsuit case.

Preferably, in order to provide information of the professional services to the public, the processor module is further configured for executing instructions stored in a non-volatile memory to realize transmitting information of the lawsuit case to the fourth client-side components of users via the network and the networking module prior to said step of receiving grades.

Preferably, in order to encourage the professional practices of the lawyers and/or the judges of the lawsuit cases, the processor module is further configured for executing instructions stored in a non-volatile memory to realize receiving a grades of information of the professional services, which includes a document provided by a user, the lawyer or a judge of the lawsuit case.

Preferably, in order to notify the public that which lawyers are awarded, the processor module is further configured for executing instructions stored in a non-volatile memory to realize transmitting the award citations, which are based on the calculated score of the grades, to the fourth client-side components of users via the network and the networking module.

Preferably, in order to encourage the public giving unbiased grades, the processor module is further configured for executing instructions stored in a non-volatile memory to realize calculating differences of the grades between the received grades and their corresponding calculated scores, respectively; and transmitting an award citation to the fourth client-side component of one of the users who gives one of the grades corresponding to the lowest one of the differences via the network and the networking module.

Preferably, in order to provide advertisements to users for sustaining the network information system and providing monetary rewards to the awarded lawyers, said transmitting the description of the newly establishing lawsuit case, said transmitting the received one or more requests, and said transmitting information of the lawsuit case further comprise transmitting advertisements or related information from an advertisement server.

Preferably, in order to robotic and fake accounts hacking into the network information system, the processor module is further configured for executing instructions stored in a non-volatile memory to realize authenticating the fourth client-side component of the user via a second network before said step of receiving grades.

According to an embodiment of the present application, a system comprises a server computer, a fourth client computer and a second client computer. The server computer comprises a networking module for connecting to a network; and a processor module, connected to the networking module and configured for executing instructions stored in a non-volatile memory to realize: receiving grades of information of professional services, stored in a database management system, from fourth client-side component of users via the network and the networking module; calculating scores of the received grades; and transmitting award citations to second client-side components of service providers who are corresponding to the highest scores via the network. The second client computer comprises: a second networking module for connecting to the network; and a second processor module, connected to the second networking module and configured for executing instructions stored in a non-volatile memory to realize the second client-side component. The fourth client computer comprises: a fourth networking module for connecting to the network; and a fourth processor module, connected to the second networking module and configured for executing instructions stored in a non-volatile memory to realize the fourth client-side component.

Preferably, in order to provide opportunities to pro bono lawyers, the service providers are lawyers, the processor module is further configured for executing instructions stored in a non-volatile memory to realize: receiving description of a lawsuit case from a first client-side component of a litigant via the network and the networking module and establishing a new lawsuit case in the database management system according to the description; transmitting the description of the newly establishing lawsuit case to the second client-side components of lawyers via the network and the networking module; receiving one or more requests from the second client-side components of lawyers via the network and the networking module; transmitting the received one or more request to the first client-side component of the litigant via the network and the networking module; and receiving a selection of the request(s) from the first client-side component of the litigant via the network and the networking module and associating the lawyer with the lawsuit case and the litigant. The system further comprises a first client computer. The first client computer comprises: a first networking module for connecting to the network; and a first processor module, connected to the first networking module and configured for executing instructions stored in a non-volatile memory to realize the first client-side component.

Preferably, in order to provide more details of the lawsuit case, the processor module is further configured for executing instructions stored in a non-volatile memory to realize receiving documents of the lawsuit case from a court server, a third client-side component of a court worker, or the fourth client-side components of users via the network and the networking module and associating the documents with the lawsuit case. The system further comprises a third client computer, comprising: a third networking module for connecting to the network; and a third processor module, connected to the third networking module and configured for executing instructions stored in a non-volatile memory to realize the third client-side component.

Preferably, in order to provide information of the professional services to the public, the processor module is further configured for executing instructions stored in a non-volatile memory to realize transmitting information of the professional services to the fourth client-side components of users via the network and the networking module prior to said step of receiving grades.

Preferably, in order to encourage the professions of the lawyers and/or the judges of the lawsuit cases, the grades of information of the professional services, which includes a document provided by a user, the lawyer or a judge of the lawsuit case from the fourth client-side component of the user via the network and the networking module.

Preferably, in order to notify the public that which lawyers are awarded, the processor module is further configured for executing instructions stored in a non-volatile memory to realize: transmitting the award citations, which are based on the calculated score of the grades, to the fourth client-side components of users via the network and the networking module.

Preferably, in order to encourage the public giving unbiased grades, the processor module is further configured for executing instructions stored in a non-volatile memory to realize calculating differences of the grades between the received grades and their corresponding calculated scores, respectively; and transmitting an award citation to the fourth client-side component of one of the users who gives one of the grades corresponding to the lowest one of the differences via the network and the networking module.

Preferably, in order to advertisements to users for sustaining the network information system and providing monetary rewards to the awarded lawyers, said transmitting the description of the newly establishing lawsuit case, said transmitting the received one or more requests, and said transmitting information of the lawsuit case further comprise transmitting advertisements or related information from an advertisement server.

Preferably, in order to prevent robotic and fake accounts hacking into the network information system, the processor module is further configured for executing instructions stored in a non-volatile memory to realize: authenticating the fourth client-side component of the user via a second network before said step of receiving grades.

Through the advertising, the system can obtain incomes from watching and clicking the advertisements shown at the client computers. The incomes can be used to sustain the operations of the network information system. After deducting the expenses, the remaining money can be used to reward the best professional service providers such as lawyers (for example, top 10% in scores) who help people in needs freely. This system makes a good circular loop for the responsible professional service providers (e.g., lawyers) and the society, particularly for those young and enthusiastic professional service providers who can accumulate work experience and reputations for themselves and earn some money the system. By competing for the awards and the rewards, the professional service providers would serve their clients with all hearts and improves gradually.

For the public, this system can help them to get not only free but also qualitative professional services (e.g., legal assistances). This raises costs of crime; thus, it encourages people being an honest, kind and integrity person. Judges would become more serious when hearing cases because the users of the system pay attention to the lawsuit cases. If the qualities of the verdicts are not good enough, public opinion provided by the system may be used as a supervision tool to the judges. As the professional services are improved by the public opinions and award citations as well as rewards provided by the network information system, the public supervision and encouragement create a positive spiral upward force to our society.

### BRIEF DESCRIPTION OF THE DRAWINGS

The advantages and spirit related to the present invention can be further understood via the following detailed description and drawings.

FIG. 1 illustrates a block diagram of a network information system 100 in accordance with an embodiment of the present application.

FIG. 2 shows a block diagram of the server 110 in accordance with an embodiment of the present invention.

FIG. 3 depicts a block diagram of a computer 300 in accordance with an embodiment of the present application.

FIG. 4 depicts relations between data entities in accordance with an embodiment of the present application.

FIGS. 5A and 5B illustrate a flowchart diagram of a method 500 in accordance with an embodiment of the present application.

### DETAILED DESCRIPTION OF THE PREFERRED EMBODIMENT

Some embodiments of the present application are described in detail below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

The present invention intends to disclose a network information system for providing opportunities to professional service providers, such as lawyers, having wills to provide free or charged professional services to those people, such as litigants, in need. Via this network information system, people can have chances to review the provided services of these service providers (e.g., enthusiastic lawyers) and even to grade the serviced results (e.g., the judgements over these lawsuits). The best service providers (e.g., lawyers) selected by users of the network information system may be rewarded by incomes of advertisements of this network information system. Although the embodiments provided in this application use professional legal services as examples, scopes of the present application are not limited in the professional legal services. The network information system and method can be used to grade any professional services and to award the professional service providers.

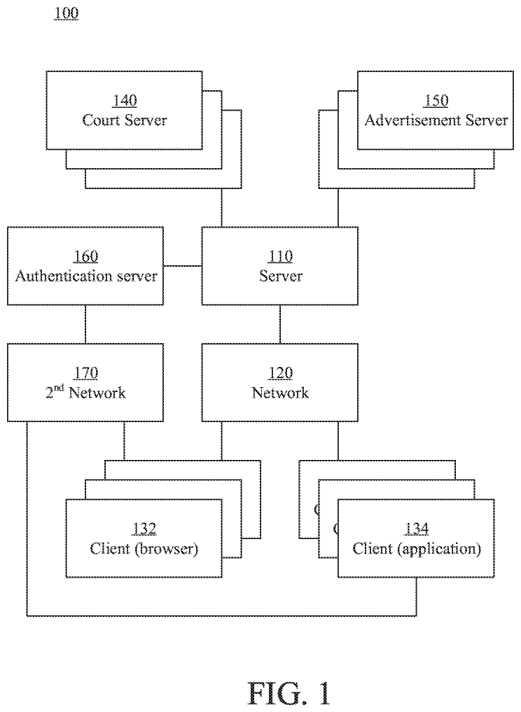

Please refer to FIG. 1, which illustrates a block diagram of a network information system 100 in accordance with an embodiment of the present application. The network information system 100 may be a client-server architecture having clients and a server interconnected via a network. The server 110 may be referred to a server computer which executes a server-side software which implements functionalities of the network information system. For examples, the server-side software may perform authentications of users, managements of lawsuit cases, managements of users and interconnections to other kinds of servers.

A client-side software may be executed by a client computer or the client 132 such as desktop computers, laptop computers, tablet computers, smartphones, personal digital assistant computers and any other kinds of computers. As shown in FIG. 1, a client-side software, downloaded from the server 110 via a network 120, is performed by a web browser, e.g., Google Chrome, Microsoft Edge, Apple Safari, Firefox and etc., which is installed in the client 132. The client-side software may be compliant to industrial standards such as Hypertext Make Up Language (HTML) or XML.

Another kind of client-side software may be executed by another client computer or the client 134 such as desktop computers, laptop computers, tablet computers, smartphones, personal digital assistant computers and any other kinds of computers. This kind of client-side software is package as an executable application runs on an operating system environment provided by the client 134. For examples, this kind of client-side software may be available for download at online software markets such as Google Play, Apple App Store etc. Users can download and install this kind of client-side software or so-called App in their client computers 134. The client-side software App may communicate with the server-side software by proprietary communication protocols. In an embodiment, the proprietary communication protocols are built on XML technologies.

When a user login in and access to the network information system, the client-side software may display advertisement arranged by the server-side software. The client 132 or 134 may directly download the advertisements from the advertisement server 150. Or alternatively, the client 132 or 134 may download the advertisements via the server 110. The server 110 may connect to one or more advertisement server 150 to manage the advertisements being provided. The advertisement server 150 may report to the server-side software about how many advertisements being provided to the users, how many times and how long the users watch the advertisements, how many clicks the users place on the advertisement and etc.

The server 110 may directly or indirectly connect to one or more court servers 140 for accessing lawsuit documents. The documents may not be limited to paper form. For examples, audio files and video files with regard to a lawsuit case may be taken as “documents” in the present application. The server 110 can also verify whether the lawsuits exist by case numbers provided by the user.

In order to authenticate user, the server 110 may connect to an authentication server 160. For example, the authentication server 160 may be a telecommunication SMS (short message server) or MMS (multimedia message server) which connects to the client computer 132 or 134 via a second network 170 (e.g., a wireless telecommunication network). For example, the server 110 may provide a text to the user via the authentication server 160 and the second network 170. The user operates on the client computer 132 or 134 may input the text via the network 120. Thus, the server-side software may think the information provided by the user is real and the user is authenticated.

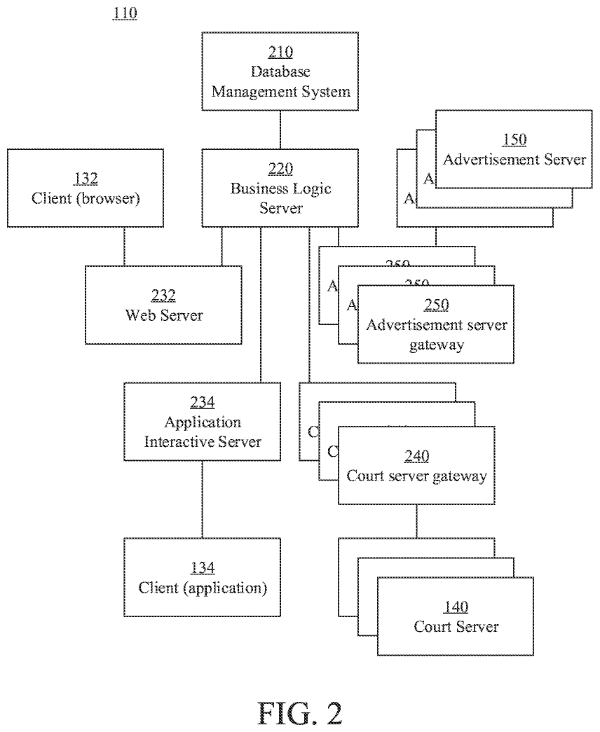

Please refer to FIG. 2, which shows a block diagram of the server 110 in accordance with an embodiment of the present invention. The server 110 may be implemented in a three-tier architecture, which includes a first tier of database management system 210, a second tier of business logic server 220, and a third tier of user interface server such as a web server 232 or an application interactive server 234. The three-tier architecture does not mean that there must be three physical computers to implement the three tiers individually. Person having ordinary skill in the art can understand that the three-tier architecture is an industrial standard definitions of software components. It does not require to implement them in three computers. For examples, the DBMS 210 may be one of non-relational databases (e.g. IBM Cloudant, InterSystems IRIS and Couchbase) and relational databases such as Oracle Database, DB2, MySQL, Microsoft SQL server etc. The business logic server 220 may be Oracle J2EE server, KingTayTay server, and Cloud BPM workflow etc.

The web server 232 is supposed to communicate with the web browser installed in the client 132 in industrial standard HTML or XML. For example, well-known Apache web server may be used. The application interactive server 234 may communicate with the App installed in the client 134 in proprietary protocols. The servers 232 and 234 are responsible for transmitting and receiving information to and from the client-side software. The information would be processed in the business logic server 220 according to business logics provided by the present patent application. Some information needs to be stored is sent to the DBMS 210 for storage. In response, the business logic server 220 may operate data retrieved from the DBMS 210 and produce outcomes to the servers 232 and 234 which further format the outcomes and transmit them to the corresponding client-side software installed in the client computers 132 and 134.

In order to communicate with the court servers 140 and the advertisement servers 150, there may be court server gateways 240 and advertisement server gateways 250, respectively. These gateways 240 and/or 250 translate the proprietary protocols for the business logic server 220. In this way, anyone of the gateway 240 and 250 can be tailor-made for each of the court server 140 and the advertisement server 150. From the perspective of the business logic server 220, the gateways 240 and 250 provides a layer of abstraction to communicate with the court server 140 and the advertisement server 150. The layer of abstraction provides a common interface of these servers 140 and 150 to the business logic server 220. It makes more convenient for providers of the business logic.

These gateways 240 and 250 may be software adapters for connecting with the intended servers 140 and 150. They may be installed and operated in a computer independent to the business logic server 220. Or alternatively, the gateways 240 and 250 are software components run on the same machine of the business logic server 220. The logic connections between the gateways 240 and 250 and their respective servers 140 and 150 may be built on top of the network 120 as shown in FIG. 1, too. For examples, VPN (virtual private network) tunnels may be used over the public network 120. Alternatively, a dedicated line may be used to connect one of the gateways 240 and 250 and one of the servers 140 and 150. In some embodiments, dedicated logic circuits are added in the machines which operates as the gateways 240 and 250 for providing encryption and decryption of communication contents.

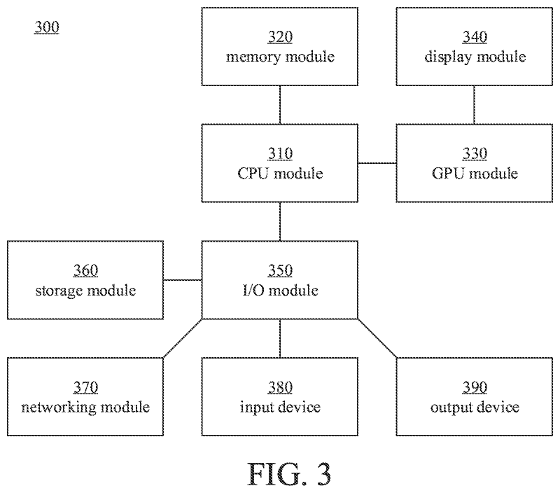

Please refer to FIG. 3, which depicts a block diagram of a computer 300 in accordance with an embodiment of the present application. The computer 300 may be used to execute software components of the client-side software (web browser and App), the DBMS 210, the business logic server 220, the web server 232, the application interactive server 234, the court server gateway 240 and/or the advertisement server gateway 250.

The computer 300 may comprise a CPU module or a processor module 310, a memory module 320, a GPU module 330, a display module 340, an Input/Output module 350, a storage module 360, at least one networking module 370, an input device 380 and an output device 390. Types of the input device 380 may include touch pad, touch screen, mouse, keyboard, camera, microphone, scanner etc. for producing text, picture, photo, audio and/or video clips. Types of the output device 390 may include display, speaker, projector, and printer etc. for displaying, playing, or printing text, picture, photo, audio and/or video clips.

The CPU module or processor module 310 comprises at least one central processor unit such as Intel, AMD, VIA Technologies x86/x64 series, ARM, Power series processors. The CPU module 310 is supposed to execute an operating system, e.g., Microsoft Windows, Linux, UNIX, Mac OS, iOS, and Android etc., for controlling the whole computer 300. The software components as shown in the FIG. 2 may be executed under the operating system environment.

The operating system and software components disclosed by the present application are loaded from the storage module 360 to the memory module 320 for execution. The storage module 360 may comprises EEPROM, disk, floppy, and non-volatile memory etc. An optional GPU (graphical processing unit) module 330 and an optional display module 340 are supposed to display. The I/O module 350 is used to bridge various input/output devices with the CPU module 310. For example, the I/O module 350 may comprise one or more buses such PCI-Express, SCSI, AHB, USB, and Firewire etc. The networking module 370 may comprises one or more MODEM logic circuits, antennas, amplifiers, and filters for connecting the network 120 and/or the second network 170. For examples, the networking module 370 comprises industrial standard networking devices such as IEEE 802.3, IEEE 802.11, Blue Tooth, 3GPP 3G, 4G, 5G, 6G compliance devices. Optional input devices and output devices such as keyboard, mouses, touch pad and etc. may be attached to the I/O module 350.

Because the system 100 provided by the present application relies on networking for connecting the server-side component and the client-side components, it cannot be implemented without networking. Moreover, the advertisements including video clips (e.g., at least several millions of bytes of data) must be transmitted on the fly over the network 120. The content may be determined according to the user by the advertisement server. This mechanism relies on the network and computing power for providing advertisements. Obviously, the system 100, which cannot be realized without the electronic network and the computer, is significantly more than an abstract idea.

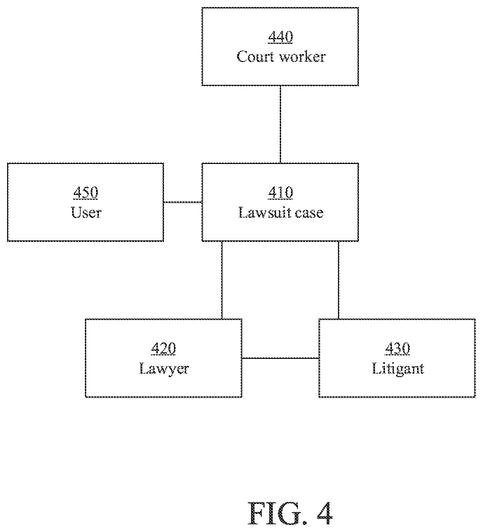

Please refer to FIG. 4, which depicts relations between data entities in accordance with an embodiment of the present application. The data entities represent generally data tuples and their properties stored in the DBMS 210. A user 450 is able to access the system 100. For examples, a user 450 is granted to access the documents of the lawsuit cases and grade the lawyers 420 and the judges of the lawsuit cases. The grade for the lawyer and the judge is not directly connected to the verdict of the lawsuit cases. When a lawyer wins a lawsuit, it does not imply that the lawyer performs well in the lawsuit. Contrary, when a lawyer loses a lawsuit case, it does not imply that the lawyer performs bad in the lawsuit. A user 450 is encouraged to give a lawyer a grade based on his/her performance in a lawsuit case, not just according to the outcome of the lawsuit case. This grading principle to the lawyers also applies the grading to the judges. Should the verdict of the lawsuit case reflect virtue, justice, and fairness. The user is also encouraged to give a judge a grade based on his/her judgements in the lawsuit case. The grade may be a count of stars, say 1 to 5 stars. The grade may be a number from 1 to 10. Once the grade is given, it may not be altered.

In some embodiments, in addition to the grade, the user 450 may leave feedbacks or words to the lawyers and the judges. The feedbacks or words may be set privately for the lawyers and the judges only. For good lawyers and judges, voices of the public may encourage them via this network information system. For those lawyers and judges who does not perform well enough, voices of the public may motivate them via this network information system. In addition to intangible encouragement, incomes from the advertisements may provide physical rewards to those good lawyers which receive best grades in this network information system.

Usually, a user 450 may be authenticated before being granted to access the system 100. In an example, the server-side component may provide a text or a number to the client computer 132 or 134 of the user 450 via the authentication server 160 and the second network 170. The user 450 may input the text and the number in the client computer 132 or 134 to the server-side component of the server 110. Once the received text or number is determined identical to the provided one, the server-side component may authenticate that the user 450 is real.

Data of a lawsuit case 410 may comprise some properties such as case number, plaintiff, defendant, judge, clerk, lawyers, summary, verdict, and documents presented before the courts. A user 450 may pay attention to some specified lawsuit cases 410. The server-side component may “push” or promptly present news or changes of the specified lawsuit cases 410 to the user 450.

There are three kinds of special users 450 being associated with a lawsuit case 410 in the system 100. They are lawyers 420, litigants 430, and court worker 440. Additional authentication procedures may be performed on these kinds of special users 450. In one embodiment, these three kinds of special users 450 may have to go through original authentication process. The server-side component may correlate a lawsuit case 410 with a lawyer 420 and a litigant 430.

A litigant 430 may be plaintiff or defendant of a lawsuit case 410. A lawyer 420 may have a power of attorney of a litigant 430 before a court. A court worker 440 may be a clerk or a judge of the court who can provide documents of the lawsuit cases 410 to the system 100.

The server-side components of the system 100 may manage these five kinds of data structures in the DBMS 210. The management of data entities may include creating a new data entity, deleting, and modifying an existing data entity. Searching the data entities with certain conditions is also a part of the data management.

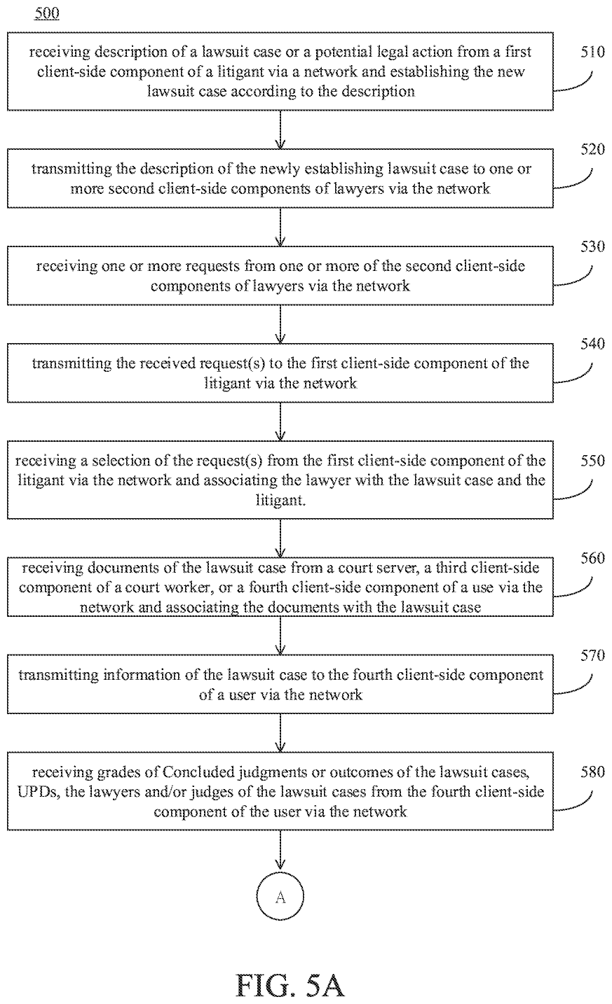

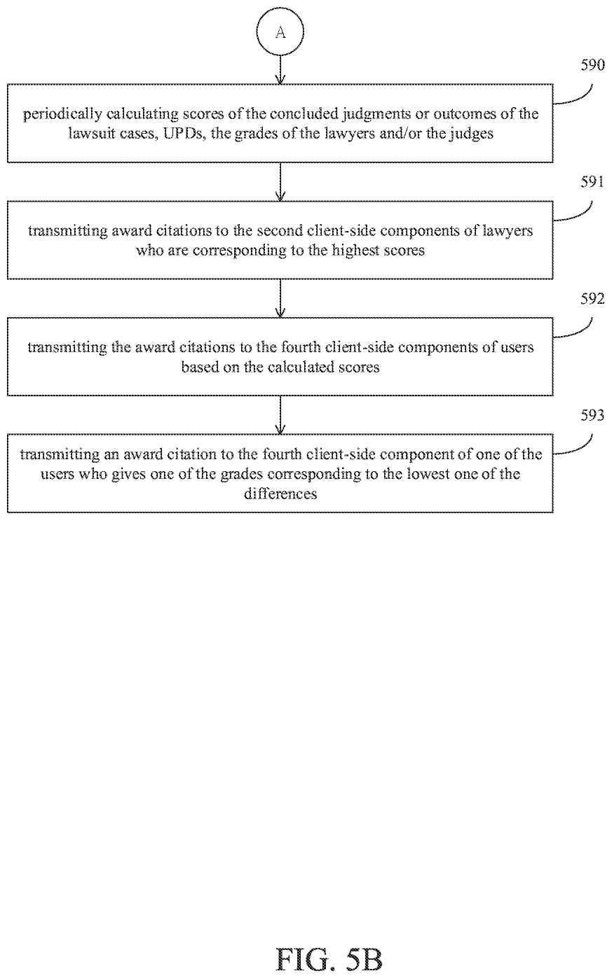

Please refer to FIGS. 5A and 5B, which illustrate a flowchart diagram of a method 500 in accordance with an embodiment of the present application. The method 500 may be performed by the server-side components executed by the server 110 of the system 100. The server-side components may be realized as computer readable data and/or executable instructions stored in a non-volatile memory such as the storage module 360 as shown in FIG. 3. If there is no casual relation between any two steps recited in the method 500, the present application would not limit the execution order of these two steps. The method 500 may begin at step 510.

Step 510: receiving description of a lawsuit case or a potential legal action from a first client-side component of a litigant via a network and establishing the new lawsuit case according to the description. The litigant posts the description to seek helps from the lawyers.

Step 520: transmitting the description of the newly establishing lawsuit case to one or more second client-side components of lawyers via the network. If the lawyers are interested in taking the lawsuit case freely, they may request to take this lawsuit case.

Step 530: receiving one or more requests from one or more of the second client-side components of lawyers via the network. The litigant may set a deadline for receiving requests. Any requests received before the deadline may send to the litigant at once. Or the litigant may receive the request when it is presented by a lawyer.

Step 540: transmitting the received request(s) to the first client-side component of the litigant via the network. The litigant may survey histories, grades, award citations of the lawyers who placed requests and select one of them to help himself or herself.

Step 550: receiving a selection of the request(s) from the first client-side component of the litigant via the network and associating the lawyer with the lawsuit case and the litigant.

Step 560: receiving documents of the lawsuit case from a court server, a third client-side component of a court worker, or a fourth client-side component of a user via the network and associating the documents with the lawsuit case. A court worker may upload the documents of the lawsuit case manually. Or alternatively, the server-side components may automatically and/or periodically download the documents from the corresponding court server via the court server gateway. In some embodiments, a user can also provide and upload documents of his/her version of story, reports, observations, comments, documents, and/or even witness evidence. The documents provided by users may be called user provided documents (UPDs). A user may provide UPD with or without consent of the parties of lawsuit case. A court worker and a user may be authenticated first to have a privilege to upload documents. The documents may include any kinds of digital files such as drawings, photos, animations, audio files, video acting and video files. In addition to the materials presented before the court, the documents may include news, reports, papers, mails related to the lawsuit case.

Step 570: transmitting information of the lawsuit case to the fourth client-side component of a user via the network. The information of lawsuit case may comprise the aforementioned case number, plaintiff, defendant, judge, clerk, lawyers, summary, verdict, and/or documents presented before the courts.

Step 580: receiving grades (or ratings) of concluded judgments or outcomes of the lawsuit cases, UPDs, the lawyers and/or judges of the lawsuit cases from the fourth client-side component of the user via the network. In some embodiments, the grades may further include feedbacks from the fourth client-side component of the user via the network. The feedbacks may include words, drawings, audio and/or video clips. And the grades may not be altered. In one embodiment, this step may be receiving grades of information of the professional services. The professional services may be legal services related to the lawsuit case. Thus, the information of the professional services may be referred to the document provided by the user, the lawyer and the judge of the lawsuit case.

Step 590: periodically calculating scores of the grades of the concluded judgments or outcomes of the lawsuit cases, UPDs, the lawyers and/or the judges. The score may be calculated by averaging the grades. Or alternatively, the score may be calculated by weighted parameters with regard to the lawsuit cases. For example, yearly awards are calculated according to the grades of the lawyers and the judges who are associated with the lawsuit cases having verdicts in a specified year. The awards may include monetary rewards earned by the system.

Step 591: transmitting award citations to the second client-side components of lawyers who are corresponding to the highest scores.

Optional step 592: transmitting the award citations to the fourth client-side components of users based on the calculated scores.

In addition, differences between grades or ratings given by a user and corresponding calculated scores may be further calculated periodically at step 590. A sum or an average of differences corresponding to a user may reflect a bias level of the user. The sum or the average of differences gets smaller, the grades or rating given by the user get fairer. In some embodiments, one or more users who give unbiased grades or ratings in a predetermined range/standard deviations may be awarded, too. The awards may also include monetary rewards earned by the system. In some examples, the awarded user must give more than a certain number (e.g., annually 10) of grades or ratings.

Optional step 593: transmitting an award citation to the fourth client-side component of one of the users who gives one of the grades corresponding to the lowest one of the differences via the network and the networking module.

In one embodiment, any one of the transmitting steps 520, 540, and 570 may further comprises transmitting advertisements or related information from the advertisement servers. The advertisement servers may collect money from advertisers for the system. The monetary rewards of the periodical awards to the lawyers may be contributed by the advertisement incomes partially or entirely. Additionally, the method 500 may further comprises transmitting the award and/or the reward citations to the second client-side component of lawyers and the fourth client-side component of users via the network.

According to one embodiment, a method for implementing a server-side component of the network information system may comprise: receiving grades of information of professional services, stored in a database management system, from fourth client-side component of users via a network; calculating scores of the received grades; and transmitting award citations to second client-side components of service providers who are corresponding to the highest scores via the network.

Preferably, in order to provide opportunities to pro bono lawyers, wherein the service providers are lawyers, the method further comprises following steps before said step of receiving grades: receiving description of a lawsuit case from a first client-side component of a litigant via a network and establishing a new lawsuit case in the database management system according to the description; transmitting the description of the newly establishing lawsuit case to the second client-side components of lawyers via the network; receiving one or more requests from the second client-side components of lawyers via the network; transmitting the received one or more request to the first client-side component of the litigant via the network; and receiving a selection of the request(s) from the first client-side component of the litigant via the network and associating the lawyer with the lawsuit case and the litigant.

Preferably, in order to provide more details of the lawsuit case, the method further comprises receiving documents of the lawsuit case from a court server, a third client-side component of a court worker or the fourth client-side components of users via the network and associating the documents with the lawsuit case.

Preferably, in order to provide information of the professional services to the public, the method further comprises transmitting information of the professional services to the fourth client-side components of users via the network prior to said step of receiving grades.

Preferably, in order to encourage the professional practices of the lawyers and/or the judges of the lawsuit cases, the grades of information of the professional services, which includes a document provided by a user, the lawyer or a judge of the lawsuit case.

Preferably, in order to notify the public that which lawyers are awarded, the method further comprises transmitting the award citations, which are based on the calculated scores of the grades, to the fourth client-side components of users via the network.

Preferably, in order to encourage the public giving unbiased grades, the method further comprises calculating differences of the grades between the received grades and their corresponding calculated scores, respectively; and transmitting an award citation to the fourth client-side component of one of the users who gives one of the grades corresponding to the lowest one of the differences via the network.

Preferably, in order to provide advertisements to users for sustaining the network information system and providing monetary rewards to the awarded lawyers, said step of transmitting the description of the newly establishing lawsuit case, said step of transmitting the received one or more requests, and said step of transmitting information of the lawsuit case further comprise transmitting advertisements or related information from an advertisement server.

Preferably, in order to prevent robotic and fake accounts hacking into the network information system, the method further comprises authenticating the fourth client-side component of the user via a second network before said step of receiving grades.

According to an embodiment of the present application, a computer for implementing a server-side component of the network information system may comprise: a networking module for connecting to a network; and a processor module, connected to the networking module and configured for executing instructions stored in a non-volatile memory to realize: receiving grades of information of professional services, stored in a database management system, from fourth client-side component of users via the network and the networking module; calculating scores of the received grades; and transmitting award citations to second client-side components of service providers who are corresponding to the highest scores via the network.

Preferably, in order to provide opportunities to pro bono lawyers, wherein the service providers are lawyers, the processor module is further configured for executing instructions stored in a non-volatile memory to realize: receiving description of a lawsuit case from a first client-side component of a litigant via the network and the networking module and establishing a new lawsuit case in the database management system according to the description; transmitting the description of the newly establishing lawsuit case to the second client-side components of lawyers via the network and the networking module; receiving one or more requests from the second client-side components of lawyers via the network and the networking module; transmitting the received one or more request to the first client-side component of the litigant via the network and the networking module; and receiving a selection of the request(s) from the first client-side component of the litigant via the network and the networking module and associating the lawyer with the lawsuit case and the litigant.

Preferably, in order to provide more details of the lawsuit case, the processor module is further configured for executing instructions stored in a non-volatile memory to realize receiving documents of the lawsuit case from a court server, a third client-side component of a court worker, or the fourth client-side components of users via the network and the networking module and associating the documents with the lawsuit case.

Preferably, in order to provide information of the professional services to the public, the processor module is further configured for executing instructions stored in a non-volatile memory to realize transmitting information of the lawsuit case to the fourth client-side components of users via the network and the networking module prior to said step of receiving grades.

Preferably, in order to encourage the professional practices of the lawyers and/or the judges of the lawsuit cases, the processor module is further configured for executing instructions stored in a non-volatile memory to realize receiving a grades of information of the professional services, which includes a document provided by a user, the lawyer or a judge of the lawsuit case.

Preferably, in order to notify the public that which lawyers are awarded, the processor module is further configured for executing instructions stored in a non-volatile memory to realize transmitting the award citations, which are based on the calculated score of the grades, to the fourth client-side components of users via the network and the networking module.

Preferably, in order to encourage the public giving unbiased grades, the processor module is further configured for executing instructions stored in a non-volatile memory to realize calculating differences of the grades between the received grades and their corresponding calculated scores, respectively; and transmitting an award citation to the fourth client-side component of one of the users who gives one of the grades corresponding to the lowest one of the differences via the network and the networking module.

Preferably, in order to provide advertisements to users for sustaining the network information system and providing monetary rewards to the awarded lawyers, said transmitting the description of the newly establishing lawsuit case, said transmitting the received one or more requests, and said transmitting information of the lawsuit case further comprise transmitting advertisements or related information from an advertisement server.

Preferably, in order to robotic and fake accounts hacking into the network information system, the processor module is further configured for executing instructions stored in a non-volatile memory to realize authenticating the fourth client-side component of the user via a second network before said step of receiving grades.

According to an embodiment of the present application, a system comprises a server computer, a fourth client computer and a second client computer. The server computer comprises a networking module for connecting to a network; and a processor module, connected to the networking module and configured for executing instructions stored in a non-volatile memory to realize: receiving grades of information of professional services, stored in a database management system, from fourth client-side component of users via the network and the networking module; calculating scores of the received grades; and transmitting award citations to second client-side components of service providers who are corresponding to the highest scores via the network. The second client computer comprises: a second networking module for connecting to the network; and a second processor module, connected to the second networking module and configured for executing instructions stored in a non-volatile memory to realize the second client-side component. The fourth client computer comprises: a fourth networking module for connecting to the network; and a fourth processor module, connected to the second networking module and configured for executing instructions stored in a non-volatile memory to realize the fourth client-side component.

Preferably, in order to provide opportunities to pro bono lawyers, the service providers are lawyers, the processor module is further configured for executing instructions stored in a non-volatile memory to realize: receiving description of a lawsuit case from a first client-side component of a litigant via the network and the networking module and establishing a new lawsuit case in the database management system according to the description; transmitting the description of the newly establishing lawsuit case to the second client-side components of lawyers via the network and the networking module; receiving one or more requests from the second client-side components of lawyers via the network and the networking module; transmitting the received one or more request to the first client-side component of the litigant via the network and the networking module; and receiving a selection of the request(s) from the first client-side component of the litigant via the network and the networking module and associating the lawyer with the lawsuit case and the litigant. The system further comprises a first client computer. The first client computer comprises: a first networking module for connecting to the network; and a first processor module, connected to the first networking module and configured for executing instructions stored in a non-volatile memory to realize the first client-side component.

Preferably, in order to provide more details of the lawsuit case, the processor module is further configured for executing instructions stored in a non-volatile memory to realize receiving documents of the lawsuit case from a court server, a third client-side component of a court worker, or the fourth client-side components of users via the network and the networking module and associating the documents with the lawsuit case. The system further comprises a third client computer, comprising: a third networking module for connecting to the network; and a third processor module, connected to the third networking module and configured for executing instructions stored in a non-volatile memory to realize the third client-side component.

Preferably, in order to provide information of the professional services to the public, the processor module is further configured for executing instructions stored in a non-volatile memory to realize transmitting information of the professional services to the fourth client-side components of users via the network and the networking module prior to said step of receiving grades.

Preferably, in order to encourage the professions of the lawyers and/or the judges of the lawsuit cases, the grades of information of the professional services, which includes a document provided by a user, the lawyer or a judge of the lawsuit case from the fourth client-side component of the user via the network and the networking module.

Preferably, in order to notify the public that which lawyers are awarded, the processor module is further configured for executing instructions stored in a non-volatile memory to realize: transmitting the award citations, which are based on the calculated score of the grades, to the fourth client-side components of users via the network and the networking module.

Preferably, in order to encourage the public giving unbiased grades, the processor module is further configured for executing instructions stored in a non-volatile memory to realize calculating differences of the grades between the received grades and their corresponding calculated scores, respectively; and transmitting an award citation to the fourth client-side component of one of the users who gives one of the grades corresponding to the lowest one of the differences via the network and the networking module.

Preferably, in order to advertisements to users for sustaining the network information system and providing monetary rewards to the awarded lawyers, said transmitting the description of the newly establishing lawsuit case, said transmitting the received one or more requests, and said transmitting information of the lawsuit case further comprise transmitting advertisements or related information from an advertisement server.

Preferably, in order to prevent robotic and fake accounts hacking into the network information system, the processor module is further configured for executing instructions stored in a non-volatile memory to realize: authenticating the fourth client-side component of the user via a second network before said step of receiving grades.

Through the advertising, the system can obtain incomes from watching and clicking the advertisements shown at the client computers. The incomes can be used to sustain the operations of the network information system. After deducting the expenses, the remaining money can be used to reward the best professional service providers such as lawyers (for example, top 10% in scores) who help people in needs freely. This system makes a good circular loop for the responsible professional service providers (e.g., lawyers) and the society, particularly for those young and enthusiastic professional service providers who can accumulate work experience and reputations for themselves and earn some money the system. By competing for the awards and the rewards, the professional service providers would serve their clients with all hearts and improves gradually.

For the public, this system can help them to get not only free but also qualitative professional services (e.g., legal assistances). This raises costs of crime; thus, it encourages people being an honest, kind and integrity person. Judges would become more serious when hearing cases because the users of the system pay attention to the lawsuit cases. If the qualities of the verdicts are not good enough, public opinion provided by the system may be used as a supervision tool to the judges. As the professional services are improved by the public opinions and award citations as well as rewards provided by the network information system, the public supervision and encouragement create a positive spiral upward force to our society.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method, comprising:
receiving grades of information of professional services, stored in a database management system, from fourth client-side component of users via a network;
calculating scores of the received grades; and
transmitting award citations to second client-side components of service providers who are corresponding to the highest scores via the network.

2. The method of claim 1, wherein the service providers are lawyers, the method further comprises following steps before said step of receiving grades:
receiving description of a lawsuit case from a first client-side component of a litigant via a network and establishing a new lawsuit case in the database management system according to the description;
transmitting the description of the newly establishing lawsuit case to the second client-side components of lawyers via the network;
receiving one or more requests from the second client-side components of lawyers via the network;
transmitting the received one or more request to the first client-side component of the litigant via the network; and
receiving a selection of the request(s) from the first client-side component of the litigant via the network and associating the lawyer with the lawsuit case and the litigant.

3. The method of claim 2, further comprises:
receiving documents of the lawsuit case from a court server, a third client-side component of a court worker, or the fourth client-side components of users via the network and associating the documents with the lawsuit case.

4. The method of claim 1, further comprises:
transmitting information of the professional services to the fourth client-side components of users via the network prior to said step of receiving grades.

5. The method of claim 2, wherein the grades of information of the professional services, which includes a document provided by a user, the lawyer or a judge of the lawsuit case.

6. The method of claim 2, further comprises:
transmitting the award citations, which are based on the calculated scores of the grades, to the fourth client-side components of users via the network.

7. The method of claim 2, further comprises:
calculating differences of the grades between the received grades and their corresponding calculated scores, respectively; and
transmitting an award citation to the fourth client-side component of one of the users who gives one of the grades corresponding to the lowest one of the differences via the network.

8. The method of claim 2, wherein said step of transmitting the description of the newly establishing lawsuit case, said step of transmitting the received one or more requests, and said step of transmitting information of the lawsuit case further comprise transmitting advertisements or related information from an advertisement server.

9. The method of claim 1, further comprises:
authenticating the fourth client-side component of the user via a second network before said step of receiving grades.

10. A computer, comprising:
a networking module for connecting to a network; and
a processor module, connected to the networking module and configured for executing instructions stored in a non-volatile memory to realize:
receiving grades of information of professional services, stored in a database management system, from fourth client-side component of users via the network and the networking module;
calculating scores of the received grades; and
transmitting award citations to second client-side components of service providers who are corresponding to the highest scores via the network.

11. The computer of claim 10, wherein the service providers are lawyers, the processor module is further configured for executing instructions stored in a non-volatile memory to realize:
receiving description of a lawsuit case from a first client-side component of a litigant via the network and the networking module and establishing a new lawsuit case in the database management system according to the description;
transmitting the description of the newly establishing lawsuit case to the second client-side components of lawyers via the network and the networking module;
receiving one or more requests from the second client-side components of lawyers via the network and the networking module;
transmitting the received one or more request to the first client-side component of the litigant via the network and the networking module; and
receiving a selection of the request(s) from the first client-side component of the litigant via the network and the networking module and associating the lawyer with the lawsuit case and the litigant.

12. The computer of claim 11, wherein the processor module is further configured for executing instructions stored in a non-volatile memory to realize:
receiving documents of the lawsuit case from a court server, a third client-side component of a court worker, or the fourth client-side components of users via the network and the networking module and associating the documents with the lawsuit case.

13. The computer of claim 10, wherein the processor module is further configured for executing instructions stored in a non-volatile memory to realize:
transmitting information of the professional services to the fourth client-side components of users via the network and the networking module prior to said step of receiving grades.

14. The computer of claim 11, wherein the grades of information of the professional services, which includes a document provided by a user, the lawyer or a judge of the lawsuit case.

15. The computer of claim 11, wherein the processor module is further configured for executing instructions stored in a non-volatile memory to realize:
transmitting the award citations, which are based on the calculated score of the grades, to the fourth client-side components of users via the network and the networking module.

16. The computer of claim 11, wherein the processor module is further configured for executing instructions stored in a non-volatile memory to realize:
calculating differences of the grades between the received grades and their corresponding calculated scores, respectively; and
transmitting an award citation to the fourth client-side component of one of the users who gives one of the grades corresponding to the lowest one of the differences via the network and the networking module.

17. The computer of claim 11, wherein said transmitting the description of the newly establishing lawsuit case, said transmitting the received one or more requests, and said transmitting information of the lawsuit case further comprise transmitting advertisements or related information from an advertisement server.

18. The computer of claim 10, wherein the processor module is further configured for executing instructions stored in a non-volatile memory to realize:
authenticating the fourth client-side component of the user via a second network before said step of receiving grades.

19. A system, comprising:
a server computer, comprising:
a networking module for connecting to a network; and
a processor module, connected to the networking module and configured for executing instructions stored in a non-volatile memory to realize:
receiving grades of information of professional services, stored in a database management system, from fourth client-side component of users via the network and the networking module;
calculating scores of the received grades; and
transmitting award citations to second client-side components of service providers who are corresponding to the highest scores via the network;
a second client computer, comprising:
a second networking module for connecting to the network; and
a second processor module, connected to the second networking module and configured for executing instructions stored in a non-volatile memory to realize the second client-side component; and
a fourth client computer, comprising:
a fourth networking module for connecting to the network; and
a fourth processor module, connected to the fourth networking module and configured for executing instructions stored in a non-volatile memory to realize the fourth client-side component.

20. The system of claim 19, wherein the service providers are lawyers, the processor module is further configured for executing instructions stored in a non-volatile memory to realize:
receiving description of a lawsuit case from a first client-side component of a litigant via the network and the networking module and establishing a new lawsuit case in the database management system according to the description;
transmitting the description of the newly establishing lawsuit case to the second client-side components of lawyers via the network and the networking module;
receiving one or more requests from the second client-side components of lawyers via the network and the networking module;
transmitting the received one or more request to the first client-side component of the litigant via the network and the networking module; and
receiving a selection of the request(s) from the first client-side component of the litigant via the network and the networking module and associating the lawyer with the lawsuit case and the litigant;
wherein the system further comprises a first client computer, comprising:
a first networking module for connecting to the network; and
a first processor module, connected to the first networking module and configured for executing instructions stored in a non-volatile memory to realize the first client-side component.

21. The system of claim 20, wherein the processor module is further configured for executing instructions stored in a non-volatile memory to realize:
receiving documents of the lawsuit case from a court server, a third client-side component of a court worker, or the fourth client-side components of users via the network and the networking module and associating the documents with the lawsuit case,
wherein the system further comprises a third client computer, comprising:
a third networking module for connecting to the network; and
a third processor module, connected to the third networking module and configured for executing instructions stored in a non-volatile memory to realize the third client-side component.

22. The system of claim 19, wherein the processor module is further configured for executing instructions stored in a non-volatile memory to realize:
transmitting information of the professional services to the fourth client-side components of users via the network and the networking module prior to said step of receiving grades.

23. The system of claim 20, wherein the grades of information of the professional services, which includes a document provided by a user, the lawyer or a judge of the lawsuit case.

24. The system of claim 20, wherein the processor module is further configured for executing instructions stored in a non-volatile memory to realize:
transmitting the award citations, which are based on the calculated score of the grades, to the fourth client-side components of users via the network and the networking module.

25. The system of claim 20, wherein the processor module is further configured for executing instructions stored in a non-volatile memory to realize:
calculating differences of the grades between the received grades and their corresponding calculated scores, respectively; and
transmitting an award citation to the fourth client-side component of one of the users who gives one of the grades corresponding to the lowest one of the differences via the network and the networking module.

26. The system of claim 20, wherein said transmitting the description of the newly establishing lawsuit case, said transmitting the received one or more requests, and said transmitting information of the lawsuit case further comprise transmitting advertisements or related information from an advertisement server.

27. The system of claim 19, wherein the processor module is further configured for executing instructions stored in a non-volatile memory to realize:
authenticating the fourth client-side component of the user via a second network before said step of receiving grades.
